(19) United States
(12) Patent Application Publication
(10) Pub. No.: US 2005/0065233 A1
(43) Pub. Date: Mar. 24, 2005

(54) Manufacturing method of the grip rubber for the exercise device

(76) Inventor: Wang-Pin Pan, Chi-Lung City (TW)

Correspondence Address: TROXELL LAW OFFICE PLLC, SUITE 1404, 5205 LEESBURG PIKE, FALLS CHURCH, VA, 22041, US

(21) Appl. No.: 10/665,340

(22) Filed: Sep. 22, 2003

(51) Int. Cl. C08K 3/00

(52) U.S. Cl. 523/122

(57) ABSTRACT

The invention herein relating to a manufacturing method of the grip rubber for the exercise device, more especially, the manufacturing method of the mildewproof and antibacterial grip rubber for the exercise device is characterized that during the manufacturing process of the grip rubber, the mildewproof, the antibacterial and the aromatic agents are added or the manufactured grip rubber is immersed in the mixed liquid of the mildewproof, the antibacterial and the aromatic agents, to allow the mildewproof, the antibacterial and the aromatic agents to attach to the grip rubber and thus to achieve the mildewproof and antibacterial effect.

### BACKGROUND OF THE INVENTION

1) Field of the Invention

The invention herein is a manufacturing method of the mildewproof and antibacterial grip rubber for the exercise device, mainly by spreading the mildewproof, the antibacterial and the aromatic agents over the grip rubber or immersing the grip rubber in the mixed liquid of the mildewproof, the antibacterial and the aromatic agents to allow the mildewproof, the antibacterial and the aromatic agents to attach to the grip rubber thus to achieve the mildewproof and the antibacterial objectives.

2) Description of the Prior Art

Along with the approaching of the industrial and commercial era, the steps of people's lives become busier, the social appointments increase more and many kinds of physical pain start to occur. Therefore, people try all kinds of sports to exercise their bodies and improve the blood circulation in order to achieve the objective of fitness building and relaxing. Wherein, the ball sports have been preferred by many people, especially those using the devices to smite, such as the badminton, the baseball, the gulf, etc. All the handle portions of the ball sports mentioned above have the grip rubber. The grip rubber is manufactured by diluting the DMF (dimethylformamide) solvent into the PU (polyurethane) resin; then the mixed liquid will be spread on the surface of the non-woven fabrics; finally, the grip rubber will be immersed in the water to let the PU resin to freeze and finish the manufacture. Wherein, since the DMF solvent is a high watery substance, it will penetrate the surface of the freezing and molding PU resin to form air holes thus to make the grip rubber capable of venting the heat and absorbing the sweat. Although the mentioned grip rubber provides the comfortable grip for the user, the mildewing situation and bacterial reproduction will happen due to long-time sweat absorbing and exposing in the rain (water absorbing). That causes trouble and inconvenience in using.

Therefore, how to make the grip rubber have the mildewproof and antibacterial effect is the urgent problem for the manufacturer to overcome.

### SUMMARY OF THE INVENTION

In view of the forgoing section, the inventor of the invention herein, based on the experience and knowledge cumulated from engaging in related fields for many years, after continuous researches and experiments, finally culminated a manufacturing method of a mildewproof and antibacterial grip rubber for the exercise device, mainly by adding and mixing the mildewproof, the antibacterial and the aromatic agents to the PU resin diluting by the DMF solvent; then by spreading the mixture on the non-woven fabrics, and finally by immersing the grip rubber frozen and molded by the PU resin immersed in the water, thus to allow the mildewproof, the antibacterial and the aromatic agents to be absorbed and attached to the grip rubber to have the efficiency of being mildewproof and antibacterial.

Therefore, the primary objective of the invention herein is to provide a manufacturing method of the grip rubber for the exercise device, wherein, through the attachment and the absorption of the mildewproof, the antibacterial and the aromatic agents to make the grip rubber have the mildewproof and antibacterial effect, and at the same time, the odor caused by the cumulated sweat can be eliminated so as to achieve the objective of being sterilized and odorless.

The following detailed description is provided to enable a further understanding of the features and the innovation of the invention herein,

### DETAILED DESCRIPTION OF THE PREFERRED EMBODIMENTS

First, the PU resin is added to the DMF solvent for diluting, then the mildewproof, the antibacterial and the aromatic agents are added to mix, wherein the mildewproof and the antibacterial agents can be shown as the chemical solvent as: 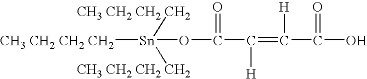
Then the mixed substance will be spread onto the non-woven fabrics and fastened to the handle portion of the exercise device; finally, the grip rubber will be immersed in the water to allow the PU resin to freeze and mold; therefore, the mildewproof, the antibacterial and the aromatic agents are attached to the grip rubber to make it have the mildewproof and antibacterial effect.

For sure that the invention herein can also be manufactured by first molding the grip rubber, then immersing it in the mixed liquid of the mildewproof, the antibacterial and the aromatic agents to permit the mildewproof, the antibacterial and aromatic agents attach to it and to make the grip rubber have the effect of being mildewproof, antibacterial and eliminating the odor.

Embodiment 1:

(1) PU (polyurethane) resin+DMF (dimethylformamide)+0.3% of a mildewproof antibacterial agent+0.1% of an aromatic agent, and stir dilution for approximately 10˜20 minutes. Depending on different viscosity requirements of the PU resin, add 50%˜100% dosage of the DMF accordingly.

(2) Spread resulting substance from (1) above on to a non-woven fabric. Upon spreading on to the non-woven fabric, the substance will have soaked into the non-woven fabric and absorbed by fiber of the non-woven fabric.

(3) Soak the non-woven fabric resulting from (2) above in water for approximately 10˜20 minutes to bleed out the PU, thereupon PU molds onto the non-woven fabric surface, at the same time hydrophilicity of the DMF allows moisture to exchange with the DMF and thereby enable pores to be caught within the PU mold.

(4) Remaining moisture can be dried out under normal temperatures or by heating equipment (temperature above 20° C.).

(5) After drying out, the mildewproof antibacterial agent and the aromatic agent are adsorbed onto a handle rubber.

(6) Cut the handle rubber to a specific width, then wrap the handle rubber on to a handle grip.

Embodiment 2

(1) The PU (polyurethane) resin+the DMF (dimethylformamide). Depending on different viscosity requirements of the PU resin, add 50%˜100% dosage of the DMF accordingly.

(2) Spread resulting substance from (1) above on to a non-woven fabric. Upon spreading on to the non-woven fabric, the substance will have soaked into the non-woven fabric and absorbed by fiber of the non-woven fabric.

(3) Add 0.3% of mildewproof antibacterial agent and 0.1% of aromatic agent to water.

(4) Soak the non-woven fabric resulting from (2) above in solution resulting from (3) above for approximately 10˜20 minutes to bleed out the PU, thereupon PU molds onto the non-woven fabric surface, at the same time hydrophilicity of the DMF allows moisture to exchange with the DMF and thereby enable pores to be caught within the PU mold.

(5) Remaining moisture can be dried out under normal temperatures or by heating equipment (temperature above 20° C.).

(6) After drying out, the mildewproof antibacterial agent and the aromatic agent are adsorbed onto the handle rubber.

(7) Cut the handle rubber to a specific width, then wrap the handle rubber on to a handle grip.

In summation of the foregoing sections, the invention herein, relating to the manufacturing method of the grip rubber for the exercise device capable of definitely eliminating the situation of bacterial reproduction and the odor occurred on the grip rubber, and providing sanitary and comfortable holding for the exercise device, complies with all new patent application requirements and is hereby submitted to the patent bureau for review and the granting of the commensurate patent rights.

1. A manufacturing method of the grip rubber for an exercise device, comprising the steps of first diluting a pu resin by adding the pu resin to a dmf solvent, followed by adding and mixing mildewproof, antibacterial and aromatic agents into the resin-solvent mixture, wherein the mildewproof and the antibacterial agents is a chemical solvent shown as: 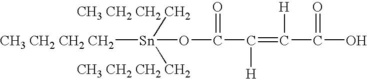
then the mixed substance will be spread onto non-woven fabrics and fastened to a handle portion of the exercise device; finally, the grip rubber will be immersed in the water to allow the PU resin to freeze and mold; or the molded grip rubber can be immersed in the mixed liquid of the mildewproof, the antibacterial and the aromatic agents to absorb the mildewproof, the antibacterial and the aromatic agents; therefore, the mildewproof, antibacterial and aromatic agents can combine with the grip rubber thereby eliminating odor and imparting resistance to mildew and bacteria.
